(19) United States
(12) Patent Application Publication
(10) Pub. No.: US 2026/0169175 A1
(43) Pub. Date: Jun. 18, 2026

(54) METHOD AND APPARATUS FOR GENERATING A PLURALITY OF TIME WINDOWS USED IN SIGNAL INTEGRATION PROCESSING

(71) Applicant: CANON MEDICAL SYSTEMS CORPORATION, Tochigi (JP)

(72) Inventors: Yi QIANG, Vernon Hills, IL (US); Kent BURR, Vernon Hills, IL (US); Cheryl SALEY, Vernon Hills, IL (US)

(73) Assignee: CANON MEDICAL SYSTEMS CORPORATION, Tochigi (JP)

(21) Appl. No.: 18/984,556

(22) Filed: Dec. 17, 2024

(51) Int. Cl. G01T 1/164; G01T 1/29

(52) U.S. Cl. CPC G01T 1/1647; G01T 1/1642; G01T 1/2985

(57) ABSTRACT

A medical imaging system that uses a plurality of time windows in signal integration is provided. The medical imaging system includes a gamma-ray detector, a set of digital readout channels, and a window generator. The gamma-ray detector includes a crystal array and a photosensor array. The photosensor array generates electrical signals in response to receiving incident scintillation light emitted from the crystal array in response to a gamma-ray interaction occurring in the crystal array. The set of digital readout channels acquires the electrical signals and generates a set of digital signals indicating information relating to the gamma-ray interaction. Each channel of the set of digital readout channels includes a charge integrator and an analog-to-digital converter. The window generator generates a plurality of time windows and a single analog-to-digital conversion (ADC) start signal.

### BACKGROUND

### Field

This disclosure relates to medical imaging systems based on gamma-ray detection, including, but not limited to, positron emission tomography (PET) imaging systems, single-photon emission computed tomography (SPECT) imaging systems, etc.

### Description of the Related Art

In medical imaging systems based on gamma-ray detection, energy and position information of a hit can be measured through a combination of a charge integrator and an analog-to-digital converter. Typically, the charge integrator needs an integration window to define when the integration process of the input signal starts and stops.

There is a need for improved approaches that provide integration windows for signal processing in these systems.

### SUMMARY

The present disclosure relates to a medical imaging system that uses a plurality of time windows in signal integration. The medical imaging system includes a gamma-ray detector, a set of digital readout channels, and a window generator. The gamma-ray detector includes a crystal array and a photosensor array. The photosensor array generates electrical signals in response to receiving incident scintillation light emitted from the crystal array in response to a gamma-ray interaction occurring in the crystal array. The set of digital readout channels acquires the electrical signals and generates a set of digital signals indicating information relating to the gamma-ray interaction. Each channel of the set of digital readout channels includes a charge integrator and an analog-to-digital converter. The window generator generates a plurality of time windows and a single analog-to-digital conversion (ADC) start signal. Based on the generated plurality of time windows and the acquired electrical signals, the charge integrators perform respective charge integrations to generate a set of integrated signals. Based on the generated single ADC start signal, the analog-to-digital converters perform respective analog-to-digital conversions on the generated set of integrated signals in a synchronized way to generate the set of digital signals.

The disclosure additionally relates to a circuit for providing a plurality of time windows used in signal integration in a medical imaging system. The medical imaging system includes a gamma-ray detector and a set of digital readout channels. The gamma-ray detector includes a crystal array and a photosensor array. The photosensor array generates electrical signals in response to receiving incident scintillation light emitted from the crystal array in response to a gamma-ray interaction occurring in the crystal array. The set of digital readout channels acquires the electrical signals and generates a set of digital signals indicating information relating to the gamma-ray interaction. Each channel of the set of digital readout channels includes a charge integrator and an analog-to-digital converter. The circuit includes a window generator configured to generate a plurality of time windows and a single ADC start signal. Based on the generated plurality of time windows and the acquired electrical signals, the charge integrators included in the set of digital readout channels perform charge integrations to generate a set of integrated signals. Based on the generated single ADC start signal, the analog-to-digital converters included in the set of digital readout channels perform analog-to-digital conversions on the generated set of integrated signals in a synchronized way to generate the set of digital signals.

Note that this summary section does not specify every embodiment and/or incrementally novel aspect of the present disclosure or claimed invention. Instead, the summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a scenario in which multiple sets of integrators and analog-to-digital converters are used to measure summed signals related to total energy and the X and Y coordinates in a positron emission tomography (PET) detector that uses Anger logic;

FIG. 2 shows an exemplary approach of providing a plurality of integration windows and a common analog-to-digital (ADC) start signal in accordance with embodiments of the present disclosure;

FIG. 3 shows an exemplary approach of generating a plurality of integration windows and a common ADC start signal in accordance with embodiments of the present disclosure;

FIG. 4 shows an exemplary approach of generating a plurality of integration windows and a common ADC start signal in accordance with embodiments of the present disclosure;

FIG. 5 shows an exemplary approach of generating a plurality of integration windows and a common ADC start signal in accordance with embodiments of the present disclosure;

FIG. 6 shows an exemplary approach of providing a plurality of integration windows and a common ADC start signal in accordance with embodiments of the present disclosure;

FIG. 7 shows an exemplary scenario of suppressing glitches through overlaps between adjacent sub-windows in accordance with embodiments of the present disclosure;

FIG. 8 shows an exemplary approach of providing a plurality of integration windows and a common ADC start signal in accordance with embodiments of the present disclosure;

FIG. 9 shows an exemplary scenario of mitigating glitches through filtering processing applied to assembled windows in accordance with embodiments of the present disclosure;

FIG. 10A shows a perspective view of a PET scanner that can be used with the techniques described herein; and

FIG. 10B shows a schematic view of a PET scanner that can be used with the techniques described herein.

### DETAILED DESCRIPTION

The following disclosure provides embodiments or examples for implementing different features of the provided subject matter. Specific examples of components and arrangements are described below to simplify the present disclosure. These are, of course, merely examples and are not intended to be limiting.

For example, the order of discussion of the different steps as described herein has been presented for the sake of clarity. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Furthermore, as used herein, the words “a,” “an,” and the like generally carry a meaning of “one or more,” unless stated otherwise.

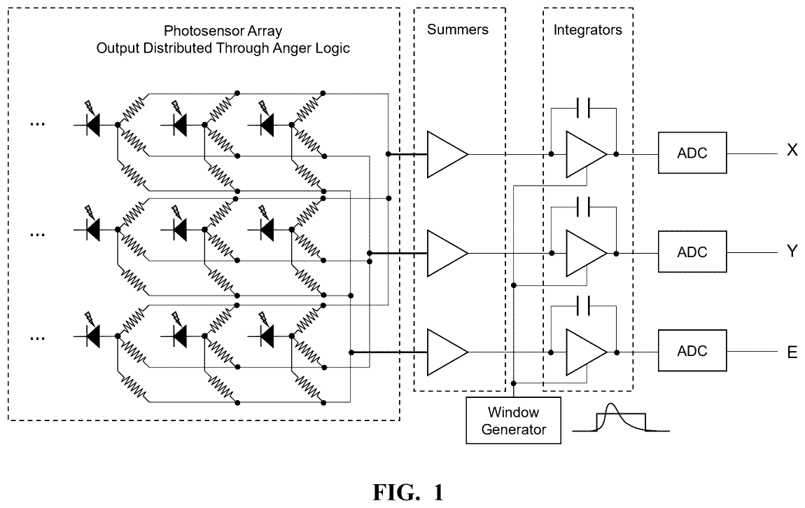

For positron emission tomography (PET) detectors that use Anger logic or a weighted sum approach, multiple sets of integrators and analog-to-digital converters are typically used to measure summed signals related to total energy and the X and Y coordinates. FIG. 1 shows a scenario of using combinations of integrators and analog-to-digital converters to measure the summed signals in a PET detector that uses Anger logic. These integrators usually share a common integration window to achieve synchronization.

In more advanced PET designs, useful information can be extracted not only from how charge is distributed geographically, but also certain critical information may be encoded in the time domain. For example, timing information from a hybrid Cherenkov/Scintillator detector is mostly contained within a short window at the beginning of the signal, while depth-of-interaction information can change the pulse shape when a slow decay phosphor is applied on one side of the crystal.

In such cases, detector performance can be enhanced by applying different integration windows to multiple integrators. Although it is possible to arrange a dedicated integration window generator for each integrator, this approach has certain challenges.

First, not all integrators need unique integration windows; typically, only two or three different window durations are actually needed. Implementing separate window generators for each integrator will lead to extra electronic components.

Second, the start of analog-to-digital conversions must be synchronized to ensure proper assembling of all integrations associated with the same event. When using separate window generators, a central unit is necessary to collect all integration windows and generate a common analog-to-digital conversion (ADC) start signal to ensure that all integrations are completed before the conversions start.

Third, the use of separate window generators can introduce increased jitter between individual integration windows, which may impact detector performance. In cases where data interpretation relies on comparisons between different integrals, e.g., using the ratio between Y and E signals to determine the Y position, mismatched integration windows can result in unstable ratios, thereby degrading the spatial resolution in reconstructed images.

The present disclosure provides a method and apparatus for solving the above-mentioned issues by providing multiple integration windows and a common analog-to-digital start signal. A shared set of integration windows and a single ADC start signal can be generated for each event. This allows individual integrators to use an integration window from the shared set, while ensuring that ADC conversions remain properly synchronized using the common start signal.

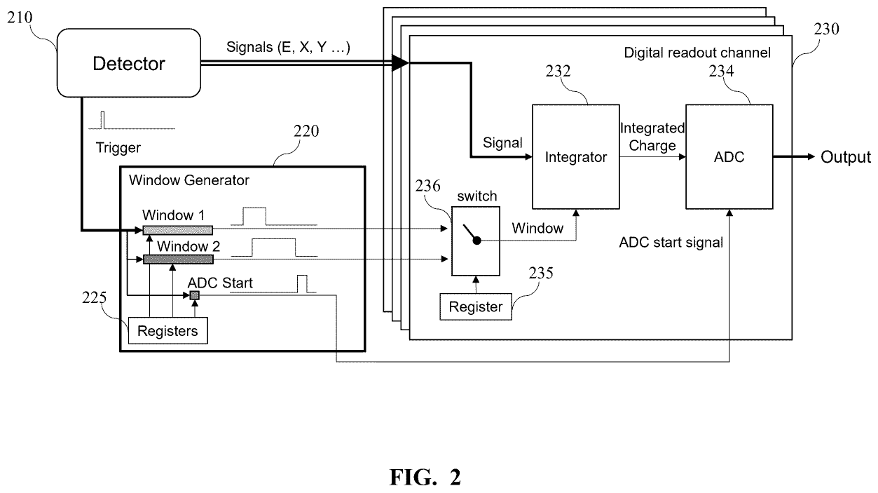

FIG. 2 shows an exemplary approach of providing a plurality of integration windows and a common ADC start signal in accordance with embodiments of the present disclosure. As shown in FIG. 2, a detector 210 detects a gamma-ray interaction occurring therein and generates electrical signals in response. These signals are read out by a set of digital readout channels 230, which convert the electrical signals into a set of digital output signals that describe information relating to the gamma-ray interaction. Each digital readout channel includes a charge integrator 232 and an analog-to-digital converter 234. The integration windows required for the charge integrations and the common ADC start signal are provided by a single circuit block, i.e., the window generator 220 in FIG. 2.

For example, upon receiving a trigger signal that indicates an event is detected by the detector, the window generator 220 generates a set of candidate integration windows (e.g., Window 1 and Window 2) and a single ADC start signal. The candidate integration windows and the ADC start signal are then be sent to the digital readout channels 230. The generation of these windows and the ADC start signal can be achieved through digital circuits by counting clock cycle, under the control of registers 225. Alternatively, the candidate integration windows and the ADC start signal can be generated using analog circuits, such as through charging processes. The waveform parameters, such as the start/stop times of the candidate integration windows, the timing of the activation edge of the ADC start signal, etc., can be pre-programmed and stored in the registers 225. While FIG. 2 shows these registers 225 as part of the window generator 220, they can be arranged outside of and accessed by the window generator 220.

The set of candidate integration windows is provided to the charge integrators 232 in the digital readout channels 230, and the ADC start signal is provided to the analog-to-digital converters 234 in the digital readout channels 230. Each integrator, under the control of a register 235 (either within the corresponding digital readout channel 230, or external but accessible to the digital readout channel 230), can select one of the candidate integration windows for charge integration, via a switch 236. As a single ADC start signal is used across all of the analog-to-digital converters 232, synchronized conversions can be achieved.

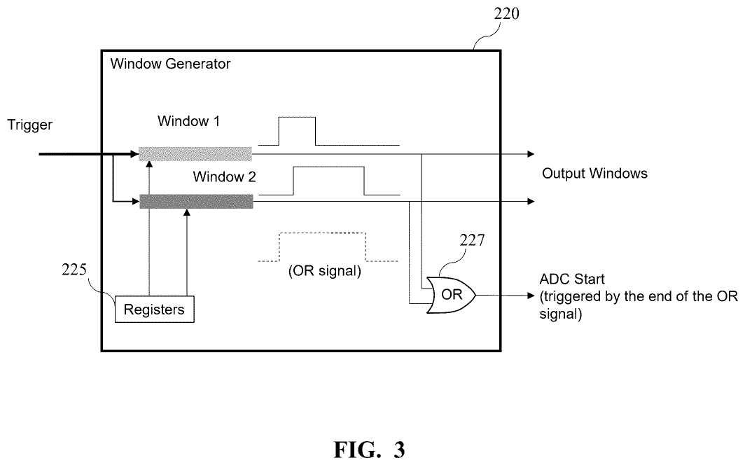

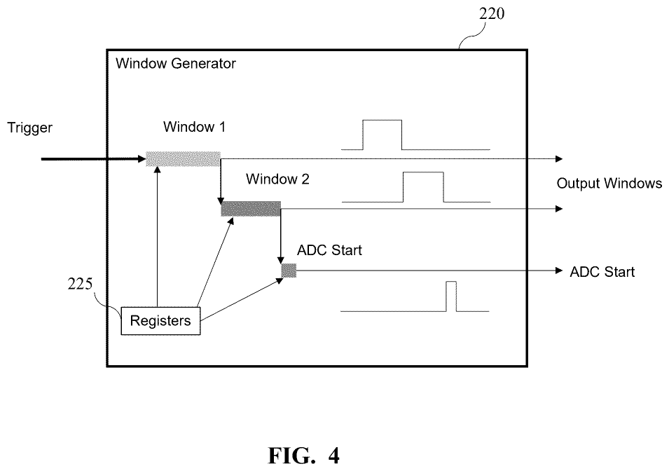

FIG. 2 illustrates an example where the candidate integration windows and the ADC start signal are generated in parallel in response to the trigger signal. FIG. 3 shows a variation in which the candidate integration windows are generated in parallel, and the ADC start signal is generated as a signal triggered by a logical operation of the candidate integration windows, e.g., triggered by the end of an OR signal of the windows that is obtained from an OR gate 227. FIG. 4 shows another example of generating the candidate integration windows and the ADC start signal. In this example, when receiving the trigger signal from the detector, the set of candidate integration windows and the ADC start signal are generated sequentially in a serial chain. No matter whether the ADC start signal is generated serially or in parallel with the candidate integration windows, a certain delay is arranged between the activation edge of the ADC start signal and the end of the last-ended one of the windows, so as to ensure that analog-to-digital conversions will not happen earlier than the end of any integration window.

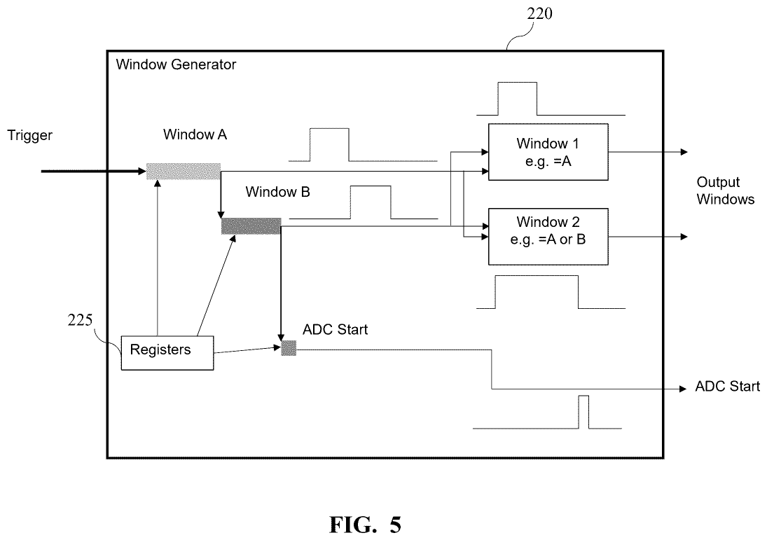

FIG. 5 shows another example where the candidate integration windows are generated in two stages. During the first stage, sub-windows (e.g., Window A, Window B, and Window C) are created under the control of the registers 225. In the second stage, the sub-windows can be assembled under the control of additional registers (not shown in FIG. 5), and the assembled windows can be provided to the charge integrators 232 as the set of candidate integration windows. Each of the assembled windows can include one or more sub-windows. For example, one candidate integration window, Window 1, can include Window A, and another candidate integration window, Window 2, can result from assembling Window A and Window B using an OR gate (not shown in FIG. 5).

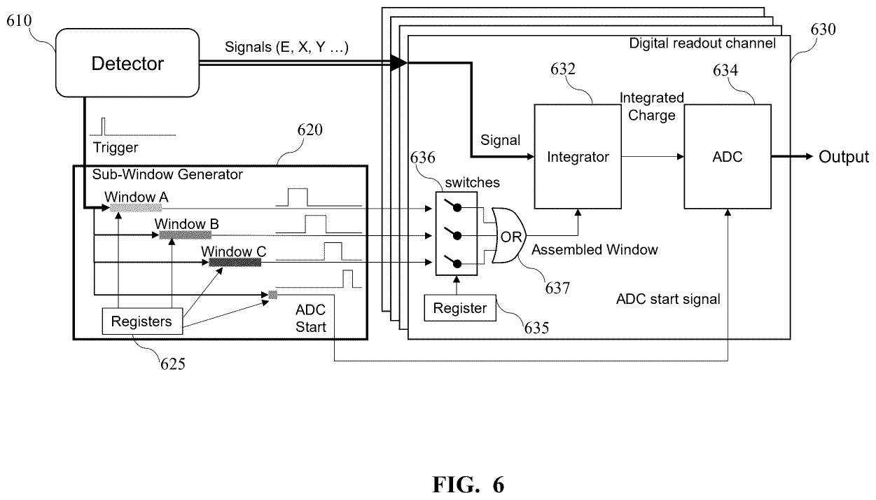

The assembling of the sub-windows can be performed at the integrators, rather than at the window generator. FIG. 6 shows an exemplary approach of providing a plurality of integration windows and a common ADC start signal in accordance with embodiments of the present disclosure. In this embodiment, under the control of registers 625 arranged within (or outside of but accessible to) a sub-window generator 620, sub-windows such as Window A, Window B, and Window C, along with a single ADC start signal, are generated. The waveforms of the sub-windows and the ADC start signal, including parameters such as the windows' start/stop times and the timing of the ADC start signal's initiation edge, are pre-programmed through the registers 625. These sub-windows are sent to the digital readout channels 630. Under the control of additional registers 635, a set of assembled windows are generated, serving as the integration windows for the respective charge integrators 632.

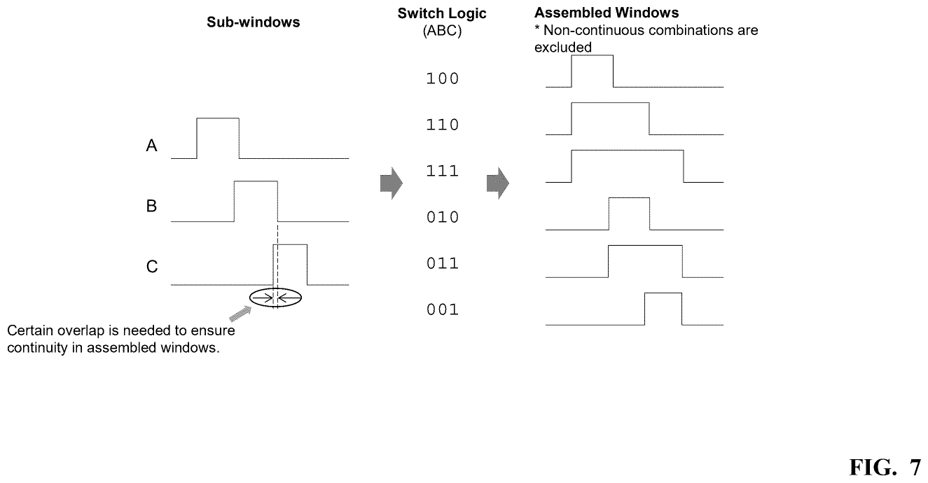

FIG. 7 shows an exemplary scenario of suppressing glitches through overlaps between adjacent sub-windows in accordance with embodiments of the present disclosure. In this example, three sub-windows A, B, and C are generated by the sub-window generator 620. By applying the illustrated switching logic of the sub-windows A, B, and C, six assembled windows can be generated, while non-continuous combinations of the sub-windows are excluded. As illustrated in FIG. 7, certain overlaps are arranged between adjacent sub-windows to ensure continuity in the assembled windows. Such overlaps can effectively prevent glitches in the assembled windows.

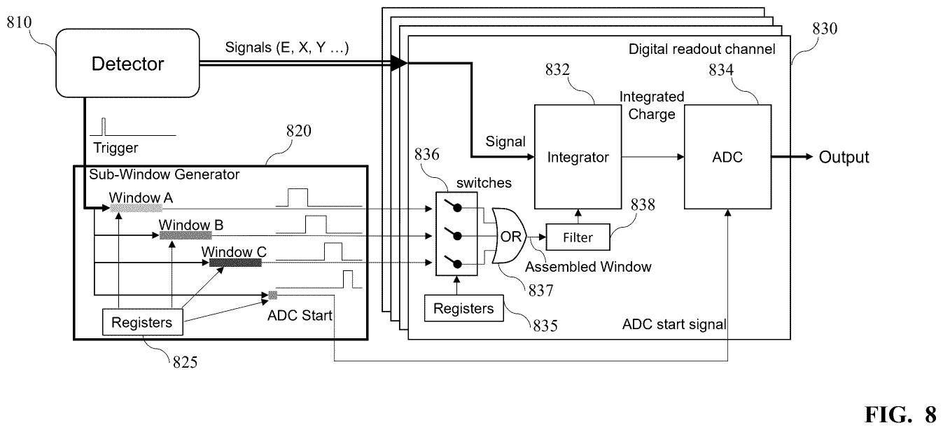

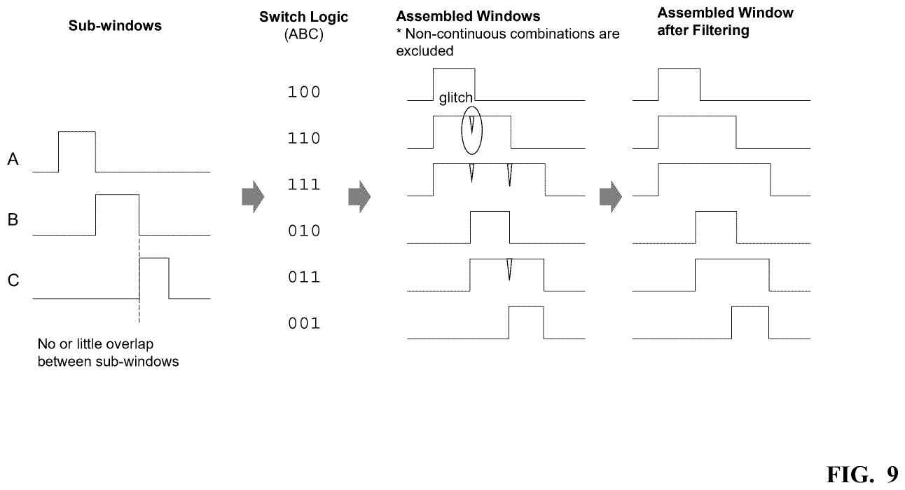

Additionally, or alternatively, filtering processing can be applied to the assembled windows to remove potential glitches. FIG. 8 shows an exemplary approach of providing a plurality of integration windows and a common ADC start signal in accordance with embodiments of the present disclosure. FIG. 9 shows an exemplary scenario of suppressing glitches through filtering processing in accordance with embodiments of the present disclosure. When no overlaps are present between adjacent sub-windows, or when overlaps are not sufficiently large, glitches in the assembled windows can be mitigated by filters 838. Although FIG. 5 does not show this explicitly, overlaps or filtering processing can also be applied to suppress potential glitches in the assembled windows.

In the examples shown in FIGS. 6 and 8, the sub-windows can be generated in parallel following the same trigger signal, or they can be generated sequentially in a serial chain. Similarly to the examples shown in FIGS. 2-5, a common ADC start signal can be generated to synchronize the analog-to-digital conversions of all integrated signals. The ADC start signal also can be configured for other purposes, e.g., serving as a master integration window, a latch signal indicating integration is ongoing, etc.

In the examples shown in FIGS. 6 and 8, the ADC start signal can be generated in parallel or sequentially with the sub-windows, based on predetermined parameters stored in the registers 625 (or 825). For example, the ADC start signal can be automatically generated based on the numerical values of the set of sub-windows, such that the activation edge of the ADC start signal is not earlier than the last integration stop time plus a certain delay. The ADC start signal also can be generated in a series chain with the sub-windows, based on a preset delay from the trigger signal, ensuring the delay is sufficient large to prevent analog-to-digital conversions from starting before any integration window has finished. Alternatively, the ADC start signal can be generated using digital logic applied on the sub-windows. For example, the ADC start signal can be triggered by an OR logical operation of the sub-windows.

The approaches described above provide additional flexibility in selecting integration windows to be used by individual integrators. A common set of windows (or sub-windows) is shared across the integrators to minimize jitter due to variations in individual window generators. An apparatus for producing these integration windows can include a common circuit block to generate a set of candidate integration windows (or a set of sub-windows). Each individual integrator chooses to use one of the candidate integration windows. A common ADC start signal is generated by the circuit block to synchronize the analog-to-digital conversions of all integrated signals. Each individual integrator also can choose more than one commonly served sub-window, and assemble them into a new integration window. In such cases, a certain overlap between adjacent sub-windows or filtering processing can be designed to ensure continuity in the assembled integration window.

Although the present disclosure is described and illustrated to provide multiple integration windows and a common ADC start signal in a medical imaging system, one of skill in related fields can recognize that the approaches provided in this disclosure are applicable in other applications where multiple time windows or gate signals are required. For instance, a set of candidate integration windows (or a set of sub-windows) can be generated in response to a preset signal of such applications. The windows (or sub-windows) can be generated automatically based on parameters stored in one or more registers, predetermined according to the application's required windows or gates. This method allows for the generation of a common ADC start signal that ensures the completeness of all integrations and synchronization of analog-to-digital conversions.

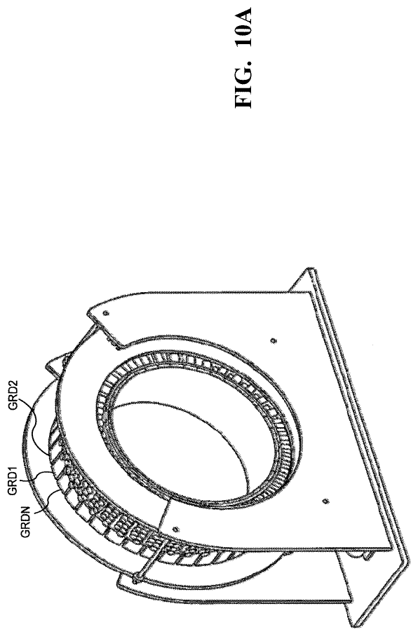

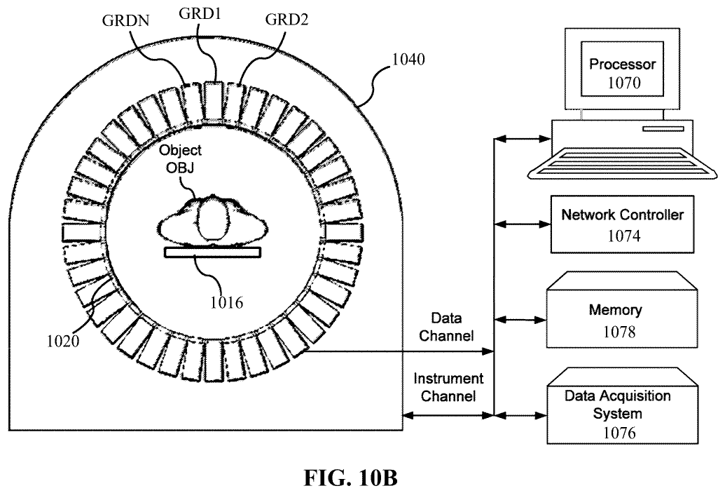

FIGS. 10A and 10B illustrate in implementation in which a medical imaging system includes a PET scanner that can implement the methods described in this disclosure. The PET scanner includes a plurality of gamma-ray detectors (GRDs) (e.g., GRD1, GRD2, through GRDN) that are each configured as rectangular detector modules.

Each GRD can include a two-dimensional array of individual detector crystals, which absorb gamma radiation and emit scintillation photons. The scintillation photons can be detected by a two-dimensional array of photodetectors or photosensors, e.g., photomultiplier tubes (PMTs), silicon photomultipliers (SiPMs), etc. A light guide can either be disposed between the array of detector crystals and the photodetectors or on the opposite end of the crystal array from the photodetectors.

Each photodetector (e.g., SiPM or PMT) can produce an analog signal that indicates when scintillation events occur, and an energy of the gamma-ray producing the detection event. Moreover, the photons emitted from one detector crystal can be detected by more than one photodetector, and, based on the analog signal produced at each photodetector, the detector crystal corresponding to the detection event can be determined using various methods, including, but not limited to, the multiplexing and analysis scheme described above, Anger logic and crystal decoding.

FIG. 10B shows one example of the arrangement of the PET scanner, in which the object OBJ to be imaged rests on a table 1016 and the GRD modules GRD1 through GRDN are arranged circumferentially around the object OBJ and the table 1016. The GRDs can be fixedly connected to a circular component 1020 that is fixedly connected to a gantry 1040. The gantry 1040 houses many parts of the PET scanner. The gantry 1040 of the PET scanner also includes an open aperture through which the object OBJ and the table 1016 can pass, and gamma-rays emitted in opposite directions from the object OBJ due to an annihilation event can be detected by the GRDs and timing and energy information can be used to determine coincidences for gamma-ray pairs.

In FIG. 10B, circuitry and hardware are also shown for acquiring, storing, processing, and distributing gamma-ray detection data. The circuitry and hardware include: a processor 1070, a network controller 1074, a memory 1078, and a data acquisition system (DAS) 1076. The PET scanner also includes a data channel that routes detection measurement results from the GRDs to the DAS 1076, the processor 1070, the memory 1078, and the network controller 1074. The data acquisition system 1076 can control the acquisition, digitization, and routing of the detection data from the detectors. In one implementation, the DAS 1076 controls the movement of the bed 1016. The processor 1070 performs functions including reconstructing images from the detection data, pre-reconstruction processing of the detection data, and post-reconstruction processing of the image data, as discussed herein.

The processor 1070 can be configured to perform various steps of the methods described herein and variations thereof. The processor 1070 can include a CPU that can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VHDL, Verilog, or any other hardware description language and the code may be stored in an electronic memory directly within the FPGA or CPLD, or as a separate electronic memory. Further, the memory may be non-volatile, such as ROM, EPROM, EEPROM or FLASH memory. The memory can also be volatile, such as static or dynamic RAM, and a processor, such as a microcontroller or microprocessor, may be provided to manage the electronic memory as well as the interaction between the FPGA or CPLD and the memory.

Alternatively, the CPU in the processor 1070 can execute a computer program including a set of computer-readable instructions that perform various steps of the described methods, the program being stored in any of the above-described non-transitory electronic memories and/or a hard disk drive, CD, DVD, FLASH drive or any other known storage media. Further, the computer-readable instructions may be provided as a utility application, background daemon, or component of an operating system, or combination thereof, executing in conjunction with a processor, such as a Xeon processor from Intel of America or an Opteron processor from AMD of America and an operating system, such as Microsoft VISTA, UNIX, Solaris, LINUX, Apple, MAC-OS and other operating systems known to those skilled in the art. Further, CPU can be implemented as multiple processors cooperatively working in parallel to perform the instructions.

The memory 1078 can be a hard disk drive, CD-ROM drive, DVD drive, FLASH drive, RAM, ROM or any other electronic storage known in the art.

The network controller 1074, such as an Intel Ethernet PRO network interface card from Intel Corporation of America, can interface between the various parts of the PET scanner. Additionally, the network controller 1074 can also interface with an external network. As can be appreciated, the external network can be a public network, such as the Internet, or a private network such as an LAN or WAN network, or any combination thereof and can also include PSTN or ISDN sub-networks. The external network can also be wired, such as an Ethernet network, or can be wireless such as a cellular network including EDGE, 3G and 4G wireless cellular systems. The wireless network can also be WiFi, Bluetooth, or any other wireless form of communication that is known.

Although the above descriptions are provided in the context of PET scanners, those skilled in the art will recognize that the disclosed concepts can be applied to other medical imaging systems based on gamma-ray detection, such as single-photon emission computed tomography (SPECT) scanners.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

Embodiments of the present disclosure may also be as set forth in the following parentheticals.

(1) A medical imaging system using a plurality of time windows in signal integration, the medical imaging system comprising: a gamma-ray detector including a crystal array and a photosensor array, the photosensor array configured to generate electrical signals in response to receiving incident scintillation light emitted from the crystal array in response to a gamma-ray interaction occurring in the crystal array; a set of digital readout channels configured to acquire the electrical signals and generate a set of digital signals indicating information relating to the gamma-ray interaction, each channel of the set of digital readout channels including a charge integrator and an analog-to-digital converter; and a window generator configured to generate a plurality of time windows and a single analog-to-digital conversion (ADC) start signal, wherein based on the generated plurality of time windows and the acquired electrical signals, the charge integrators are configured to perform respective charge integrations to generate a set of integrated signals, and based on the generated single ADC start signal, the analog-to-digital converters are configured to perform respective analog-to-digital conversions on the generated set of integrated signals in a synchronized way to generate the set of digital signals.

(2) The system of (1), wherein the window generator is further configured to generate a plurality of candidate integration windows, as the generated plurality of time windows, and each charge integrator is configured to select a specific integration window from the generated plurality of candidate integration windows, and perform the respective charge integration during the selected specific integration window.

(3) The system of (2), wherein the apparatus further comprises a first register arranged within or accessible by the window generator and a second register arranged within or accessible by the charge integrators, the first register storing a plurality of predetermined time window waveforms, the second register storing respective integration window selections of the charge integrators, the window generator is further configured to use a digital clock counter or an analog gate generator to generate the plurality of candidate integration windows, based on the plurality of predetermined time window waveforms stored in the first register, and each charge integrator is configured to select the specific integration window from the generated plurality of candidate integration windows, based on the respective integration window selections stored in the second register.

(4) The system of (3), wherein the first register further stores a predetermined signal waveform for the single ADC start signal, such that a predetermined delay is arranged between an end of a last ended one of the plurality of candidate integration windows and an activation edge of the single ADC start signal, and the window generator is further configured to, upon receiving, from the detector, a trigger signal indicating that the photosensor array received the scintillation light, generate the plurality of candidate integration windows and the single ADC start signal in parallel.

(5) The system of (3), wherein the window generator is further configured to: upon receiving, from the detector, a trigger signal indicating that the photosensor array received the scintillation light, generate the plurality of candidate integration windows in parallel, and generate a signal triggered upon a logical operation result of the plurality of candidate integration windows, as the single ADC start signal.

(6) The system of (3), wherein the first register further stores a predetermined signal waveform for the single ADC start signal, such that a predetermined delay is arranged between an end of a last ended one of the plurality of candidate integration windows and an activation edge of the single ADC start signal, and the window generator is further configured to, upon receiving, from the detector, a trigger signal indicating that the photosensor array received the scintillation light, generate the plurality of candidate integration windows and the single ADC start signal in a serial chain.

(7) The system of (3), wherein the first register is further configured to store a plurality of predetermined sub-window waveforms and a plurality of predetermined sub-window combinations, and the window generator is further configured to: based on the plurality of predetermined sub-window waveforms, generate a plurality of sub-windows, and based on the plurality of predetermined sub-window combinations, use the generated plurality of sub-windows to generate the plurality of candidate integration windows.

(8) The system of (7), wherein the first register further stores a predetermined signal waveform for the single ADC start signal, such that a predetermined delay is arranged between an end of a last ended one of the plurality of sub-windows and an activation edge of the single ADC start signal, and the window generator is further configured to, upon receiving, from the detector, a trigger signal indicating that the photosensor array received the scintillation light, generate the plurality of sub-windows and the single ADC start signal in parallel.

(9) The system of (7), wherein the window generator is further configured to: upon receiving, from the detector, a trigger signal indicating that the photosensor array received the scintillation light, generate the plurality of sub-windows in parallel, and generate a signal triggered upon a logical operation result of the plurality of sub-windows, as the single ADC start signal.

(10) The system of (7), wherein the first register further stores a predetermined signal waveform for the single ADC start signal, such that a predetermined delay is arranged between an end of a last ended one of the plurality of sub-windows and an activation edge of the single ADC start signal, and the window generator is further configured to, upon receiving, from the detector, a trigger signal indicating that the photosensor array received the scintillation light, generate the plurality of sub-windows and the single ADC start signal in a serial chain.

(11) The system of (1), wherein the window generator is further configured to generate a plurality of sub-windows, as the generated plurality of time windows, and each charge integrator corresponds to a specific combination of the plurality of sub-windows, and performs the respective charge integration during an integration window formed by the corresponding specific combination of the plurality of sub-windows.

(12) The system of (11), wherein the apparatus further comprises a first register arranged within or accessible by the window generator and a second register arranged within or accessible by the charge integrators, the first register storing a plurality of predetermined sub-window waveforms, the second register storing respective sub-window combinations of the charge integrators, the window generator is further configured to use a digital clock counter or an analog gate generator to generate the plurality of sub-windows, based on the plurality of predetermined sub-window waveforms stored in the first register, and the charge integrators perform the respective charge integrations during integration windows formed by combining the plurality of sub-windows based on their respective sub-window combinations stored in the second register.

(13) The system of (12), wherein the plurality of predetermined sub-window waveforms are arranged such that there is an overlap between two adjacent sub-windows of the plurality of sub-windows.

(14) The system of (12), wherein the charge integrators perform their respective charge integrations during integration windows generated by combining the plurality of sub-windows based on the respective sub-window combinations to form combined windows, and filtering the combined windows to suppress glitches included in the combined windows.

(15) The system of (12), wherein the first register further stores a predetermined signal waveform for the single ADC start signal, such that a predetermined delay is arranged between an end of a last ended one of the plurality of sub-windows and an activation edge of the single ADC start signal, and the window generator is further configured to, upon receiving, from the detector, a trigger signal indicating that the photosensor array received the scintillation light, generate the plurality of sub-windows and the single ADC start signal in parallel.

(16) The system of (12), wherein the window generator is further configured to: upon receiving, from the detector, a trigger signal indicating that the photosensor array received the scintillation light, generate the plurality of sub-windows in parallel, and generate a signal triggered upon a logical operation result of the plurality of sub-windows, as the single ADC start signal.

(17) The system of (12), wherein the first register further stores a predetermined signal waveform for the single ADC start signal, such that a predetermined delay is arranged between an end of a last ended one of the plurality of sub-windows and an activation edge of the single ADC start signal, and the window generator is further configured to, upon receiving, from the detector, a trigger signal indicating that the photosensor array received the scintillation light, generate the plurality of sub-windows and the single ADC start signal in a serial chain.

(18) The system of (1), wherein the window generator is further configured to output the generated single ADC start signal as a signal representing a master integration window, or as a latch signal indicating that signal integration is ongoing.

(19) The system of (1), wherein the set of digital readout channels are further configured to generate a set of digital signals representing energy, position, depth-of-interaction, and/or timing information relating to the gamma-ray interaction, as the set of digital signals describing information relating to the gamma-ray interaction.

(20) A circuit for providing a plurality of time windows used in signal integration in a medical imaging system, the medical imaging system including a gamma-ray detector and a set of digital readout channels, the gamma-ray detector including a crystal array and a photosensor array, the photosensor array generating electrical signals in response to receiving incident scintillation light emitted from the crystal array in response to a gamma-ray interaction occurring in the crystal array, the set of digital readout channels acquiring the electrical signals and generating a set of digital signals indicating information relating to the gamma-ray interaction, each channel of the set of digital readout channels including a charge integrator and an analog-to-digital converter, the circuit comprising: a window generator configured to generate a plurality of time windows and a single analog-to-digital conversion (ADC) start signal, wherein based on the generated plurality of time windows and the acquired electrical signals, the charge integrators included in the set of digital readout channels perform charge integrations to generate a set of integrated signals, and based on the generated single ADC start signal, the analog-to-digital converters included in the set of digital readout channels perform analog-to-digital conversions on the generated set of integrated signals in a synchronized way to generate the set of digital signals.

Numerous modifications and variations of the embodiments presented herein are possible in light of the above teachings. It is therefore to be understood that within the scope of the claims, the disclosure may be practiced otherwise than as specifically described herein. The inventions are not limited to the examples that have just been described; it is in particular possible to combine features of the illustrated examples with one another in variants that have not been illustrated.

What is claimed is:

1. A medical imaging system using a plurality of time windows in signal integration, the medical imaging system comprising:
a gamma-ray detector including a crystal array and a photosensor array, the photosensor array configured to generate electrical signals in response to receiving incident scintillation light emitted from the crystal array in response to a gamma-ray interaction occurring in the crystal array;
a set of digital readout channels configured to acquire the electrical signals and generate a set of digital signals indicating information relating to the gamma-ray interaction, each channel of the set of digital readout channels including a charge integrator and an analog-to-digital converter; and
a window generator configured to generate a plurality of time windows and a single analog-to-digital conversion (ADC) start signal, wherein
based on the generated plurality of time windows and the acquired electrical signals, the charge integrators are configured to perform respective charge integrations to generate a set of integrated signals, and
based on the generated single ADC start signal, the analog-to-digital converters are configured to perform respective analog-to-digital conversions on the generated set of integrated signals in a synchronized way to generate the set of digital signals.

2. The system of claim 1, wherein the window generator is further configured to generate a plurality of candidate integration windows, as the generated plurality of time windows, and
each charge integrator is configured to select a specific integration window from the generated plurality of candidate integration windows, and perform the respective charge integration during the selected specific integration window.

3. The system of claim 2, wherein the apparatus further comprises a first register arranged within or accessible by the window generator and a second register arranged within or accessible by the charge integrators, the first register storing a plurality of predetermined time window waveforms, the second register storing respective integration window selections of the charge integrators,
the window generator is further configured to use a digital clock counter or an analog gate generator to generate the plurality of candidate integration windows, based on the plurality of predetermined time window waveforms stored in the first register, and
each charge integrator is configured to select the specific integration window from the generated plurality of candidate integration windows, based on the respective integration window selections stored in the second register.

4. The system of claim 3, wherein the first register further stores a predetermined signal waveform for the single ADC start signal, such that a predetermined delay is arranged between an end of a last ended one of the plurality of candidate integration windows and an activation edge of the single ADC start signal, and
the window generator is further configured to, upon receiving, from the detector, a trigger signal indicating that the photosensor array received the scintillation light, generate the plurality of candidate integration windows and the single ADC start signal in parallel.

5. The system of claim 3, wherein the window generator is further configured to:
upon receiving, from the detector, a trigger signal indicating that the photosensor array received the scintillation light, generate the plurality of candidate integration windows in parallel, and
generate a signal triggered upon a logical operation result of the plurality of candidate integration windows, as the single ADC start signal.

6. The system of claim 3, wherein the first register further stores a predetermined signal waveform for the single ADC start signal, such that a predetermined delay is arranged between an end of a last ended one of the plurality of candidate integration windows and an activation edge of the single ADC start signal, and
the window generator is further configured to, upon receiving, from the detector, a trigger signal indicating that the photosensor array received the scintillation light, generate the plurality of candidate integration windows and the single ADC start signal in a serial chain.

7. The system of claim 3, wherein the first register is further configured to store a plurality of predetermined sub-window waveforms and a plurality of predetermined sub-window combinations, and
the window generator is further configured to:
based on the plurality of predetermined sub-window waveforms, generate a plurality of sub-windows, and
based on the plurality of predetermined sub-window combinations, use the generated plurality of sub-windows to generate the plurality of candidate integration windows.

8. The system of claim 7, wherein the first register further stores a predetermined signal waveform for the single ADC start signal, such that a predetermined delay is arranged between an end of a last ended one of the plurality of sub-windows and an activation edge of the single ADC start signal, and
the window generator is further configured to, upon receiving, from the detector, a trigger signal indicating that the photosensor array received the scintillation light, generate the plurality of sub-windows and the single ADC start signal in parallel.

9. The system of claim 7, wherein the window generator is further configured to:
upon receiving, from the detector, a trigger signal indicating that the photosensor array received the scintillation light, generate the plurality of sub-windows in parallel, and
generate a signal triggered upon a logical operation result of the plurality of sub-windows, as the single ADC start signal.

10. The system of claim 7, wherein the first register further stores a predetermined signal waveform for the single ADC start signal, such that a predetermined delay is arranged between an end of a last ended one of the plurality of sub-windows and an activation edge of the single ADC start signal, and
the window generator is further configured to, upon receiving, from the detector, a trigger signal indicating that the photosensor array received the scintillation light, generate the plurality of sub-windows and the single ADC start signal in a serial chain.

11. The system of claim 1, wherein the window generator is further configured to generate a plurality of sub-windows, as the generated plurality of time windows, and
each charge integrator corresponds to a specific combination of the plurality of sub-windows, and performs the respective charge integration during an integration window formed by the corresponding specific combination of the plurality of sub-windows.

12. The system of claim 11, wherein the apparatus further comprises a first register arranged within or accessible by the window generator and a second register arranged within or accessible by the charge integrators, the first register storing a plurality of predetermined sub-window waveforms, the second register storing respective sub-window combinations of the charge integrators,
the window generator is further configured to use a digital clock counter or an analog gate generator to generate the plurality of sub-windows, based on the plurality of predetermined sub-window waveforms stored in the first register, and
the charge integrators perform the respective charge integrations during integration windows formed by combining the plurality of sub-windows based on their respective sub-window combinations stored in the second register.

13. The system of claim 12, wherein the plurality of predetermined sub-window waveforms are arranged such that there is an overlap between two adjacent sub-windows of the plurality of sub-windows.

14. The system of claim 12, wherein the charge integrators perform their respective charge integrations during integration windows generated by combining the plurality of sub-windows based on the respective sub-window combinations to form combined windows, and filtering the combined windows to suppress glitches included in the combined windows.

15. The system of claim 12, wherein the first register further stores a predetermined signal waveform for the single ADC start signal, such that a predetermined delay is arranged between an end of a last ended one of the plurality of sub-windows and an activation edge of the single ADC start signal, and
the window generator is further configured to, upon receiving, from the detector, a trigger signal indicating that the photosensor array received the scintillation light, generate the plurality of sub-windows and the single ADC start signal in parallel.

16. The system of claim 12, wherein the window generator is further configured to:
upon receiving, from the detector, a trigger signal indicating that the photosensor array received the scintillation light, generate the plurality of sub-windows in parallel, and
generate a signal triggered upon a logical operation result of the plurality of sub-windows, as the single ADC start signal.

17. The system of claim 12, wherein the first register further stores a predetermined signal waveform for the single ADC start signal, such that a predetermined delay is arranged between an end of a last ended one of the plurality of sub-windows and an activation edge of the single ADC start signal, and
the window generator is further configured to, upon receiving, from the detector, a trigger signal indicating that the photosensor array received the scintillation light, generate the plurality of sub-windows and the single ADC start signal in a serial chain.

18. The system of claim 1, wherein the window generator is further configured to output the generated single ADC start signal as a signal representing a master integration window, or as a latch signal indicating that signal integration is ongoing.

19. The system of claim 1, wherein the set of digital readout channels are further configured to generate a set of digital signals representing energy, position, depth-of-interaction, and/or timing information relating to the gamma-ray interaction, as the set of digital signals describing information relating to the gamma-ray interaction.

20. A circuit for providing a plurality of time windows used in signal integration in a medical imaging system, the medical imaging system including a gamma-ray detector and a set of digital readout channels, the gamma-ray detector including a crystal array and a photosensor array, the photosensor array generating electrical signals in response to receiving incident scintillation light emitted from the crystal array in response to a gamma-ray interaction occurring in the crystal array, the set of digital readout channels acquiring the electrical signals and generating a set of digital signals indicating information relating to the gamma-ray interaction, each channel of the set of digital readout channels including a charge integrator and an analog-to-digital converter, the circuit comprising:
a window generator configured to generate a plurality of time windows and a single analog-to-digital conversion (ADC) start signal, wherein
based on the generated plurality of time windows and the acquired electrical signals, the charge integrators included in the set of digital readout channels perform charge integrations to generate a set of integrated signals, and
based on the generated single ADC start signal, the analog-to-digital converters included in the set of digital readout channels perform analog-to-digital conversions on the generated set of integrated signals in a synchronized way to generate the set of digital signals.
